(19) United States
(12) Patent Application Publication
(10) Pub. No.: US 2013/0061145 A1
(43) Pub. Date: Mar. 7, 2013

(54) METHOD AND SYSTEM FOR CONTROLLING A NETWORK USING A FOCAL POINT TOOL

(71) Applicants: Andrew Charles Gilbert, Devon (GB); David Leslie Golfis, Waterford, MI (US)

(72) Inventors: Andrew Charles Gilbert, Devon (GB); David Leslie Golfis, Waterford, MI (US)

(73) Assignee: SIEMENS PRODUCT LIFECYCLE MANAGEMENT SOFTWARE INC., Plano, TX (US)

(21) Appl. No.: 13/459,434

(22) Filed: Apr. 30, 2012

Related U.S. Application Data
(60) Provisional application No. 61/530,286, filed on Sep. 1, 2011.

(51) Int. Cl. G06F 3/048

(52) U.S. Cl. 715/734

(57) ABSTRACT

Product data management systems and methods. A method includes receiving, from a user, a seed data selection and retrieving PDM information related to the seed data selection. The method includes displaying a focal point selection area including a plurality of domain selections. The method includes receiving a user selection of one or more of the plurality of domain selections. The method includes generating and displaying a network map of the PDM information associated with the user selection.

### CROSS-REFERENCE TO RELATED APPLICATION

The application claims the benefit of the filing date of U.S. Provisional Patent Application 61/530,286, filed Sep. 1, 2011, which is hereby incorporated by reference.

### TECHNICAL FIELD

The present disclosure is directed, in general, to computer-aided design, visualization, and manufacturing systems, product lifecycle management (“PLM”) systems, and similar systems, that manage data for products and other items (collectively, “Product Data Management” systems or PDM systems).

### BACKGROUND OF THE DISCLOSURE

In conventional network systems, several important factors are taken into consideration when the process of building the network is undertaken or when the network is modified. Among these important factors is the determination of the layout of the network. In addition, the visibility of the network to users is another of these factors. Conventional methods and systems for establishing or modifying the layout and/or visibility of the networks have disadvantages.

### SUMMARY OF THE DISCLOSURE

This disclosure includes product data management systems and methods. A method includes receiving, from a user, a seed data selection and retrieving PDM information related to the seed data selection. The method includes displaying a focal point selection area including a plurality of domain selections. The method includes receiving a user selection of one or more of the plurality of domain selections. The method includes generating and displaying a network map of the PDM information associated with the user selection.

Other technical features may be readily apparent to one skilled in the art from the following figures, descriptions, and claims.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like Objects, and in which:

FIG. 1 depicts a block diagram of a data processing system in which an embodiment can be implemented;

FIG. 2 depicts an example of domains and relationships that can be mapped in accordance with disclosed embodiments;

FIG. 3 illustrates an example of a revised layout generated and displayed by the system in accordance with disclosed embodiments;

FIG. 4 displays an example of a focal point tool user interaction area in accordance with disclosed embodiments;

FIG. 5 shows an example of a focal point tool user interaction area in accordance with disclosed embodiments including subdomains;

FIGS. 6A and 6B show alternate formats of the focal point selection area in accordance with disclosed embodiments;

FIG. 7 shows a summary of the various user interface (UI) states and controls that can be presented by a system in accordance with disclosed embodiments; and

FIG. 8 depicts a flowchart of a process in accordance with disclosed embodiments.

### DETAILED DESCRIPTION

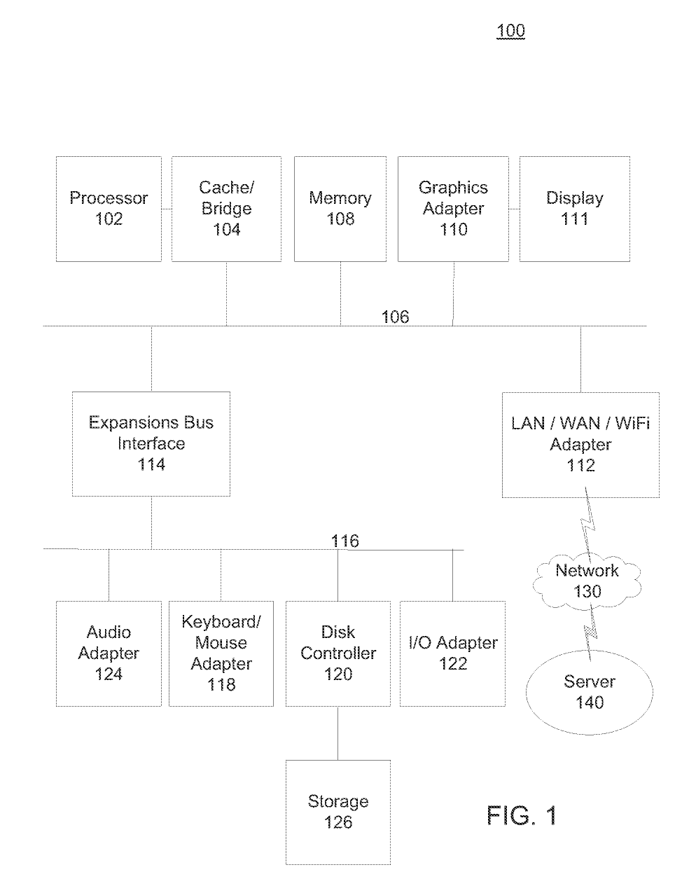

FIGS. 1 through 8, and the various embodiments used to describe the disclosed systems and methods are by way of illustration only and should not be construed in any way to limit the scope of the disclosure. Those skilled in the art will understand that the principles of the invention may be implemented in any type of suitably arranged device or system.

Disclosed embodiments include a “focal point tool”, and related systems and methods, that act as a mechanism for controlling the visibility and layout of complex networks of information related to an initial data object or seed. Various embodiments include processes to derive a network of related items of data based upon an initial seed and processes that enables a user to control the context and layout of the resulting network and to update the network based on user interaction with a user interface. Various embodiments can also save the definition and layout of a network for later retrieval.

The systems and methods described herein are unique, for example in that they provide the capability for users to discover and explore relationships within highly complex systems of information such as product lifecycle data. Disclosed embodiments are able to draw information from diverse sources and of many different types and present them in a graphical manner that is easy to understand and interpret. By providing a series of layout options to a user, the user can view the resulting network in the context that best suits their personal needs and experience.

FIG. 1 depicts a block diagram of a data processing system 100 in which an embodiment can be implemented, for example as a PDM system particularly configured by software or otherwise to perform the processes as described herein, and in particular as each one of a plurality of interconnected and communicating systems as described herein. The data processing system 100 depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system 100 in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

In accordance with this disclosure, data processing system 100 can implement a focal point tool that is capable of controlling the visibility and layout of complex networks of information. For a particular embodiment, a user may provide a piece of data that the focal point tool can use as a seed. Various settings on the focal point tool may be used in conjunction with this seed to create a network of items relating to the seed in a particular set of contexts. The focal point tool may be capable of determining this set of contexts based on user interaction.

In addition, the focal point tool may be used to change the layout of a network diagram and what is shown or made visible to the user based on user interaction with the focal point tool, which may set both the layout context and the visibility of items within the network at any given time. The resulting combination of settings may be saved by the user for later retrieval as needed.

According to disclosed embodiments, the derivation of the network of information can be generated based upon a user-supplied or user-selected piece of seed data. This can be data of any type including but not limited to a 3D part, a requirement, a manufacturing process step, etc. Based upon this seed, the tool retrieves information from the PDM system and any associated data incorporated into it, This information can be mapped into a series of domains and relationships.

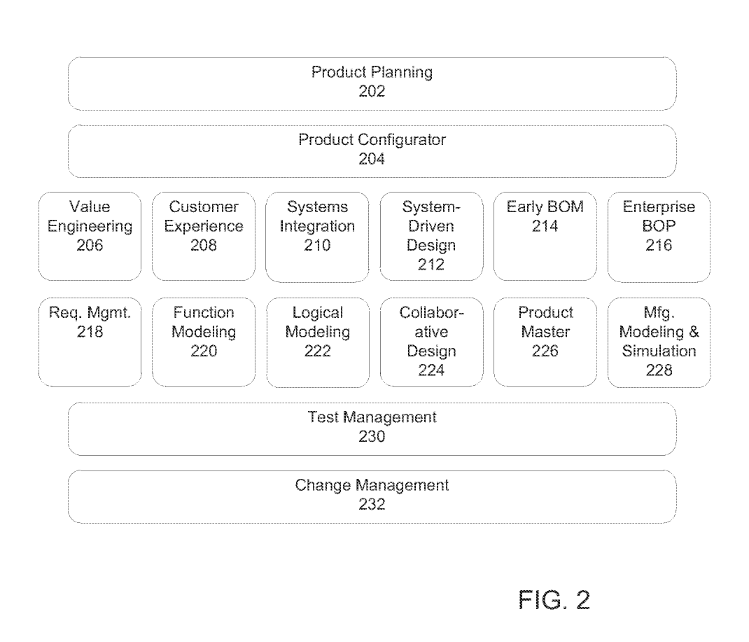

FIG. 2 depicts an example of domains and relationships that can be mapped in accordance with disclosed embodiments. Note that these are exemplary, as are the descriptions of each of the domains. In the descriptions below, each of the exemplary domains can include one or more of the constituent features described, and can include others not specifically described below.

In some embodiments, the twelve “central” domains include value engineering 206, customer experience 208, systems integration 210, system-driven design 212, early bill of materials (BOM) 214, enterprise bill of production (BOP) 216, requirements management 218, function modeling 220, logical modeling 222, collaborative design 224, product master 226, and manufacturing modeling and simulation 228.

Value engineering 206 can include tracking customer perception, features, and value propositions. Customer experience 208 can include customer-focused use case modeling, simulation, and analysis. Systems integration 210 can include top-down definition of key parameters and bottom-up rollup of predicted behavior, System-driven design 212 can include top-down specifications of key dimensions and shapes. Early BOM 214 can include top-down processes for setting up a product master during early program phases. Enterprise BOP 216 can include top-down processes for setting up common and unique processes across plants.

Requirements management 218 can include efficient authoring of requirements text and easy assignment of requirements to development activities via filters and configurations. Requirements management 218 can be presented interchangeably as documents or as lists of objects. Function modeling 220 can include actions, services, events, triggers, signals, and states. Function modeling 220 can be presented as matrices, networks, and state diagrams. Logical modeling 222 can include networks of logical system building blocks, with input and output parameters, connections, formatted messages, and associated behavior models. Logical modeling 222 can be presented as discipline-specific network diagrams. Collaborative design 224 can include flexible layouts of CAD and ECAD, software source code management, physical simulation, and can be optimized for design work and collaboration. Collaborative design 224 can be presented as 3D workspaces, networks of features or constraints, and pre- or post-design analyses. Product master 226 can include integrated official representation of parts and their usage across all orderable configurations, for all regions and plants. Product master 226 can be presented as lists and matrices, with 3D visualization. Manufacturing modeling and simulation 228 can include planning, modeling, and simulation of manufacturing processes, resulting in definition of work instructions and shop-floor routing. Manufacturing modeling and simulation 228 can be presented in a variety of formats, including as Program Evaluation and Review Technique charts, Gantt charts, networks, lists, and 3D models of plants and workstations. Manufacturing modeling and simulation 228 can also be related to corporate sales, purchasing, and order entry, and to plant-specific manufacturing resources planning and manufacturing execution systems.

Product planning 202 can include a portfolio plan, including products, customers, capital expenditures, and partnerships, market timing, program timing, investment tradeoffs, and projects. Product configurator 204 can include shared definitions of products, models, and options offered to the market, mappings to domain-specific configuration language including program configurations, alternate use scenarios, performance parameters, simulation and positioning variables, and manufacturing process variables.

Test management 230 can include closed-loop processes, test plans based on engineering inputs, and feedback of test results to all engineering activities. Change management 232 can include enterprise-wide coordination of business activities leading to and impacted by changes in product development activities.

In FIG. 2, each of the twelve central domains are directly associated with each other with a “distance” of one, indicating that there is no intervening domain between each of these. Further, the twelve central domains can each be directly associated with product planning 202, product configurator 204, test management 230, and change management 232.

The domain mappings illustrated in FIG. 2 can be used to produce and display collections of information that have specific meaning in the context of the product lifecycle and which also have a known or predefined relationship to each other. The resulting network can be further constrained by setting the “focus of interest” in one or more domains such that the network nodes can be grouped according to the user's focus and unwanted domains can be removed from the resulting network based on user-controlled settings for their visibility. The system can also provide a control to allow the network to be updated or redefined based upon one or more user inputs. Further, the system can save the parameters used to define the network for subsequent retrieval and reuse by the user.

A different network layout display, in accordance with disclosed embodiments, can be derived solely from the initial data seed, shown as physical partition. Such a display can include a focal point selection area that can be used to receive a selection from a user of one or more focal point selections to organize the displayed network nodes. For example, the user can select domains including configuration, physical, function, logical, and design. The system can then receive an “update network” selection as from an “update network” button in the focal point selection area. The focal point selection area can function as a “focal point tool” by which the system can receive the user selections.

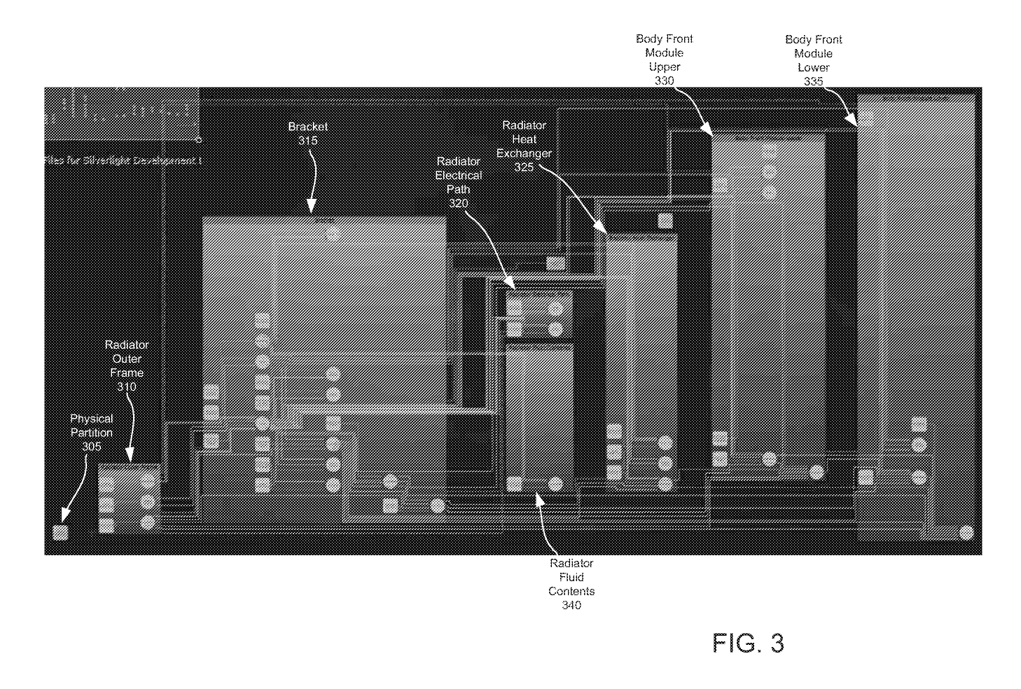

FIG. 3 illustrates an example of a revised layout generated and displayed by the system as a result of the user choosing a logical focal point that causes the network nodes to be grouped by their logical function. In this example, the network of seed physical partition 305 is organized into logical groups including radiator outer frame 310, bracket 315, radiator electrical path 320, radiator heat exchanger 325, body front module upper 330, body front module lower 335, and radiator fluid contents 340. The network display of FIG. 3 corresponds to the selection received from the user, for example, in that it uses the focal point of the seed physical partition 305, organized to focus according to the configuration, physical, showing function, logical, and design aspects.

Note that disclosed embodiments are not limited to the mappings described and illustrated herein. The various embodiments disclosed herein include a number of techniques for mapping PDM information in such a way that it can be presented in a logical manner via a network as disclosed herein or by similar methods. Disclosed embodiments include systems and methods for mapping PDM information to a predefined set of criteria such as for large engineering enterprises and other enterprises.

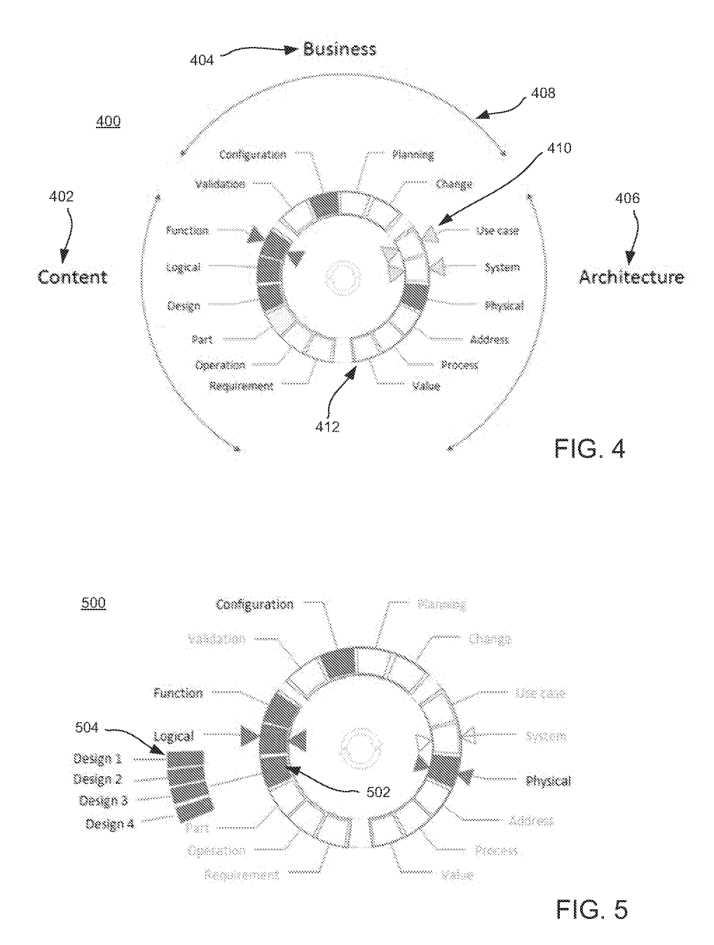

In various embodiments, the system interacts with a user via the focal point tool user selection area such as that illustrated in FIG. 4. This construct allows the system to interact with a user to control the context, layout, and content of the derived network in a highly visual and engaging manner.

FIG. 4 displays an example of a focal point tool user interaction area 400 in accordance with disclosed embodiments; while actual implementation appearances vary, the essential function remains the same in various embodiments. In this example, the user interface mechanism is divided using a domain mapping, such as that illustrated in FIG. 2, into three discrete areas that respectively include layout information relating to the general contexts of Content 402, Business 404, and Architecture 406.

The system can receive a selection from the user, in some embodiments, of up to one domain from each context as a focal point of the network diagram. The outer ring of buttons in the diagram above—with the triangle indicators 408—provides the user with the ability to select a focal point. Once a focal point has been chosen within at least one of the three contexts the remaining contexts visually distinguish between domains that can contribute (add) to the layout derived from the original focal point and the remainder which if selected would cause a new network to be derived.

Mappings such as those illustrated in FIG. 2 determine whether a domain can contribute to the current layout or will initiate the creation of a new network and consequently what the visual state of the user interface (UI) shows in the generated and displayed network. The buttons shown as triangles 410 have four states, including active as a focus, inactive but available to contribute to current focus, inactive but available to replace current focus, and unavailable in current network. The inner ring of square segments 412 relates to the visibility of network nodes belonging to a given domain. These buttons allow the user to turn visibility of available information on and off to better comprehend and explore the information presented on the screen by way of the network diagram (the network). Visibility is shown via three states of the buttons corresponding to information being shown, hidden, or unavailable (not present in the current network).

In some cases a domain may be further separated into a series of sub domains. FIG. 5 shows an example of a focal point tool user interaction area 500 in accordance with disclosed embodiments, including subdomains 504. In this example, the Design domain 502 is separated into four specific elements shown as subdomains 504. in such cases the UI design allows for a secondary UI element to be displayed that provides finer control over the network nodes displayed for a given domain.

In sonic embodiments, in order to maintain acceptable levels of performance an update button is included in the UI toot, such as an “update network” button in a focal point selection area. Such an “update network” button can be located at the center of the tool but it could be located elsewhere depending on the specific styling of the tool at any given time. The update button serves to trigger changes to the network either in terms of the layout of the current layout or the creation of a new network as dictated by domain mapping rules such as those shown in FIG. 2.

Various embodiments use a combination of graphical elements as described above and user oriented labeling to ensure that different aspects of the network can easily be understood. Combining interactive visual elements with textual indicators is a key part of the user interface design with respect to usability.

Various embodiments can display a user interface that is structured in such a way that can be styled in a number of ways based on a user's preference or on a desired style from a software development perspective but the underlying functionality remains as described herein. In addition to the general circular appearance of the focal point selection area as illustrated, the focal point selection area can also be displayed in other formats.

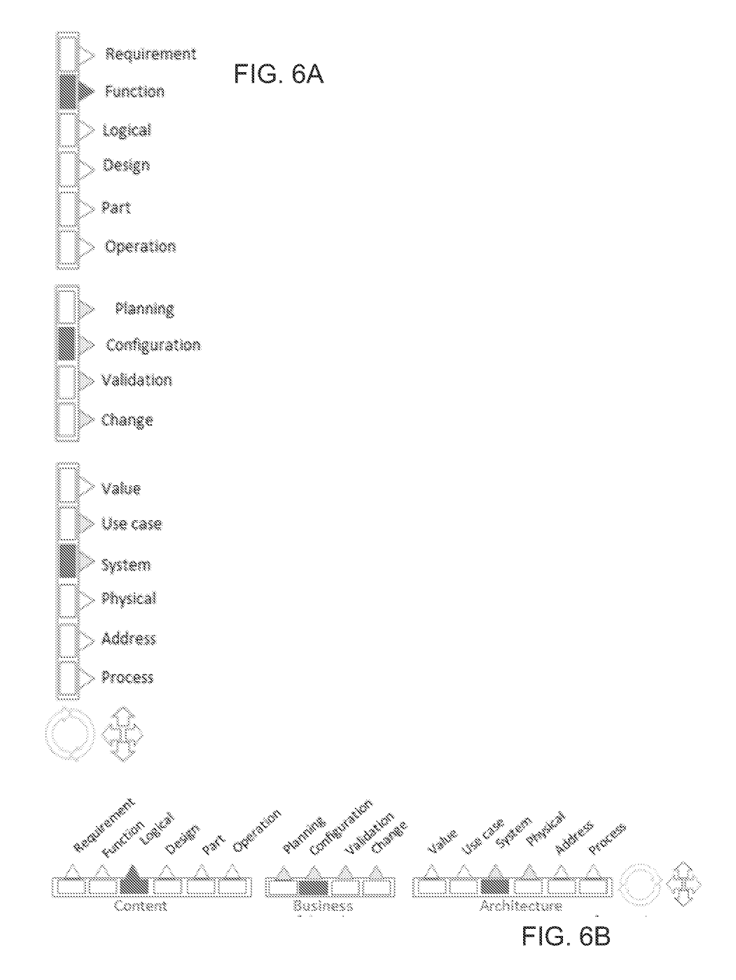

FIGS. 6A and 6B show alternate formats of the focal point selection area. A floating tool element similar to that shown to that described above can be alternately displayed, for example, as a horizontal selection area as in FIG. 6A or as a vertical selection area as in FIG. 6B. Any of the selection areas described herein may be attached to the edge of the screen or able to float over the other UI elements making up the software application.

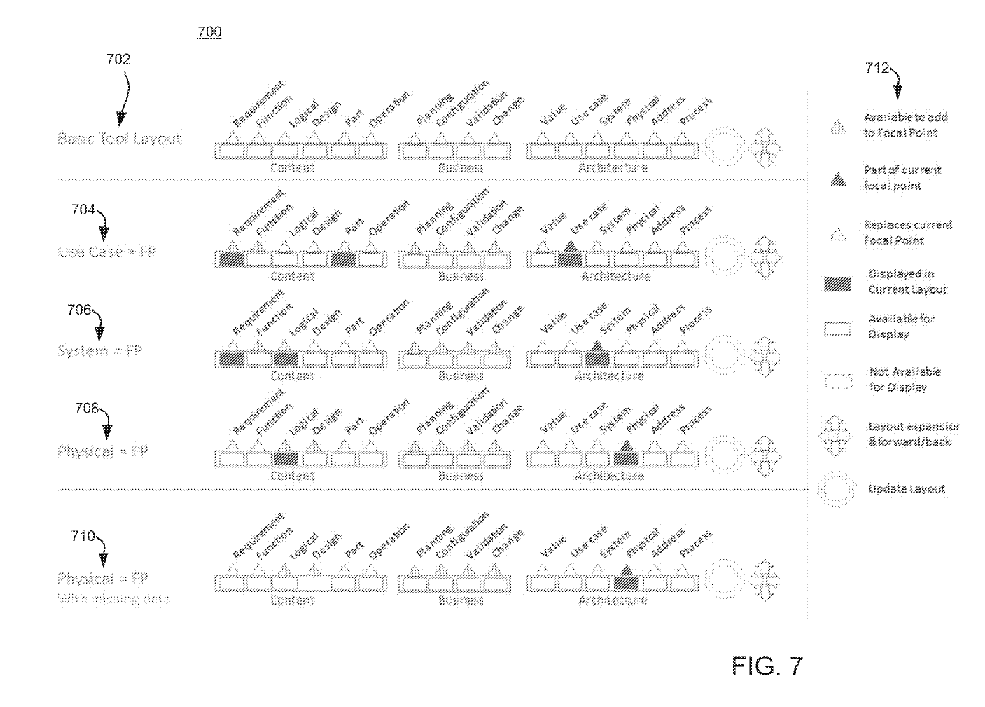

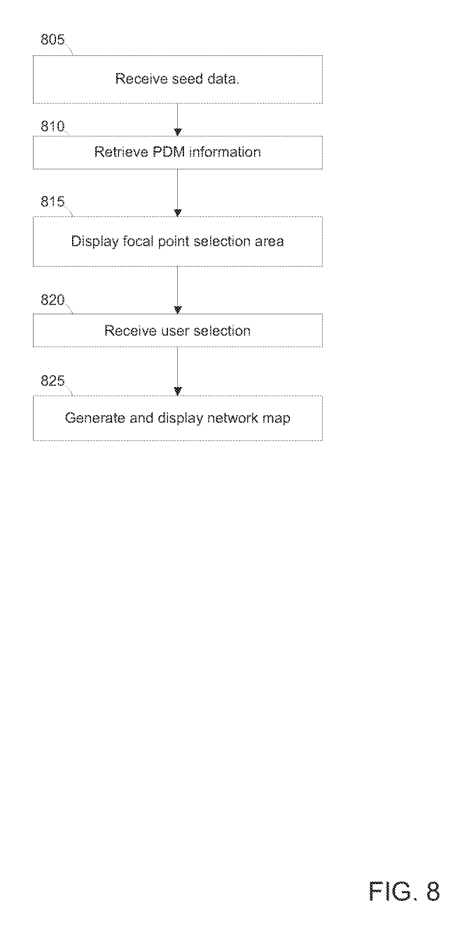

FIG. 7 shows a summary of the various UI states and controls that can be presented by a system in accordance with disclosed embodiments, and can be placed in a focal point selection area as described herein. This exemplary summary is presented with a horizontal layout for ease of viewing the different states of the tool.

Different states are shown for the basic tool layout 702, a use case focus point (FP) 704, a system focus point 706, a physical focus point 708 with complete data, and a physical focus point 710 with missing data. In physical FP 710 with missing data, Design data is not present in the query so although Design is a valid contribution to the layout and could in theory be displayed and contribute to the layout, the display box is hidden indicating that the data is not present. Missing data results in the relevant display boxes being hidden.

Legend 712 shows the various indications of blank, shaded, solid, or dashed triangles and rectangles, and buttons for layout expansion or update.

Various disclosed embodiments include an on-screen tool for receiving user input from which the system modifies the content and layout of a network diagram showing PDM information. Various embodiments also include a system of PDM-oriented rules used to create and organize the display of a network of PDM information, and can structure network diagrams based on focal points or domain-oriented approaches. Other embodiments can expand and contract the overall network based on a currently-displayed network and the mapping rules in place, and can protect the ability to export the network and its layout into a text-based format such as CSV or otherwise.

FIG. 8 depicts a flowchart of a process in accordance with disclosed embodiments, that can be performed by one or more PDM data processing systems as described herein.

The system receives, from a user, a seed data selection (step 805). The seed data selection can be, for example, a user selection from a. list of available seed data, or can be a direct input from a user. The seed data selection can correspond to a 3D part, a requirement, a manufacturing process step, or otherwise.

The system retrieves PDM information related to the selected seed data (step 810). Retrieving, in this context, can include loading from storage, receiving from another device or process, or otherwise.

The system displays a focal point selection area including a plurality of domain selections (step 815). The focal point selection area can be any of those described above, and can include any of the features and domain mappings described above. The plurality of domain selections can be arranged into groups of contexts corresponding to content, business, and architecture. The focal point selection area can display status information related to one or more of the domain selections, such as described above using the shadings, shapes, or otherwise.

The system receives a user selection of one or more of the plurality of domain selections (step 820). This step can include receiving user selections such as a touch input or mouse input on one ore more of the displayed domain selections. The user selection can include a user-selected logical focal point. The focal point selection area can be modified after at least a first one of the user selections is received to visually distinguish between domains that can contribute to a layout derived from the first one of the user selections and the domains which, if selected, would cause a new network to be derived.

The system generates and displays a network map of the PDM information associated with the user selection (step 825). This step can be automatically performed in response to receiving the user selection, or can be performed in response to a user input indicating that the network map should be generated or updated. The PDM information can be displayed as a plurality of nodes in the network map, including the relationships between the nodes. The network map can show the PDF information in groups corresponding to user selection.

Steps 815-825 can be repeated to regenerate and redisplay the network map for different user selections, and of course the entire process can be repeated. Further, in various embodiments, the steps described herein may be repeated, omitted, performed sequentially or concurrently, performed in a different order, or otherwise, in various implementations within the scope of this disclosure.

It may be advantageous to set forth definitions of certain words and phrases used throughout this patent document. The term “couple” and its derivatives refer to any direct or indirect communication between two or more elements, whether or not those elements are in physical contact with one another. The terms “application” and “program” refer to one or more computer programs, software components, sets of instructions, procedures, functions, objects, classes, instances, related data, or a portion thereof adapted for implementation in a suitable computer code (including source code, object code, or executable code). The terms “transmit,” “receive,” and “communicate,” as well as derivatives thereof, encompass both direct and indirect communication. The terms “include” and “comprise,” as well as derivatives thereof, mean inclusion without limitation. The term “obtain” and its derivatives refer to any acquisition of data or other tangible or intangible item, whether acquired from an external source or internally (such as through internal generation of the item). The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of or the like. The term “controller” means any device, system, or part thereof that controls at least one operation. A controller may be implemented in hardware, firmware, software, or some combination of at least two of the same. The functionality associated with any particular controller may be centralized or distributed, whether locally or remotely.

While this disclosure has described certain embodiments and generally associated methods, alterations, and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed:

1. A method performed by a product data management (PDM) data processing system, comprising:
receiving, from a user, a seed data selection;
retrieving PDM information related to the seed data selection;
displaying a focal point selection area including a plurality of domain selections;
receiving a user selection of one or more of the plurality of domain selections; and
generating and displaying a network map of the PDM information associated with e user selection.

2. The method of claim 1, wherein the plurality of domain selections includes one or more of value engineering, customer experience, systems integration, system-driven design, early bill of materials (BOM), enterprise bill of production (BOP), requirements management, function modeling, logical modeling, collaborative design, product master, and manufacturing modeling and simulation.

3. The method of claim 1, wherein the user selection includes a user-selected logical focal point.

4. The method of claim 1, wherein generating and displaying a network map is automatically performed in response to receiving the user selection.

5. The method of claim 1, wherein the PDM information is displayed as a plurality of nodes in the network map, including relationships between the nodes.

6. The method of claim 1, wherein the network map displays the PDF information in groups corresponding to user selection.

7. The method of claim 1, wherein the focal point selection area is divided into areas that respectively include layout information relating to a context, a business context, and an architecture context.

8. The method of claim 1, wherein the focal point selection area is modified after at least a first one of the user selections is received to visually distinguish between domains that can contribute to a layout derived from the first one of the user selections and the domains which if selected would cause a new network to be derived.

9. A product data management (PDM) data processing system, comprising:
a processor;
an accessible memory; and
a display, the PDM data processing system configured to
receive, from a user, a seed data selection;
retrieve PDM information related to the seed data selection;
display a focal point selection area including a plurality of domain selections;
receive a user selection of one or more of the plurality of domain selections; and
generate and displaying a network map of the PDM information associated with the user selection.

10. The PDM data processing system of claim 9, wherein the plurality of domain selections includes one or more of value engineering, customer experience, systems integration, system-driven design, early bill of materials (BOM), enterprise bill of production (BOP), requirements management, function modeling, logical modeling, collaborative design, product master, and manufacturing modeling and simulation.

11. The PDM data processing system of claim 9, wherein the user selection includes a user-selected logical focal point.

12. The PDM data processing system of claim 9, wherein generating and displaying a network map is automatically performed in response to receiving the user selection.

13. The PDM data processing system of claim 9, wherein the PDM information is displayed as a plurality of nodes in the network map, including relationships between the nodes.

14. The PDM data processing system of claim 9, wherein the network map displays the PDF information in groups corresponding to user selection.

15. The PDM data processing system of claim 9, wherein the focal point selection area is divided into areas that respectively include layout information relating to a context, a business context, and an architecture context.

16. The PDM data processing system of claim 9, wherein the focal point selection area is modified after at least a first one of the user selections is received to visually distinguish between domains that can contribute to a layout derived from the first one of the user selections and the domains which if selected would cause a new network to be derived.

17. A machine-readable medium encoded with machine-executable instructions that, when executed, cause a product data management (PDM) data processing system to:
receive, from a user, a seed data selection;
retrieve PDM information related to the seed data selection;
display a focal point selection area including a plurality of domain selections;
receive a user selection of one or more of the plurality of domain selections; and
generate and displaying a network map of the PDM information associated with the user selection.

18. The machine-readable medium of claim 17, wherein the plurality of domain selections includes one or more of value engineering, customer experience, systems integration, system-driven design, early bill of materials (BOM), enterprise bill of production (BOP), requirements management, function modeling, logical modeling, collaborative design, product master, and manufacturing modeling and simulation.

19. The machine-readable medium of claim 17, wherein the network map displays the PDF information in groups corresponding to user selection.

20. The machine-readable medium of claim 17, wherein the focal point selection area is modified after at least a first one of the user selections is received to visually distinguish between domains that can contribute to a layout derived from the first one of the user selections and the domains which if selected would cause a new network to be derived.
